(19) United States
(12) Patent Application Publication
(10) Pub. No.: US 2025/0251638 A1
(43) Pub. Date: Aug. 7, 2025

(54) FRONT-LIGHT GLASS DISPLAY MODULE

(71) Applicant: CHENFENG OPTRONICS CORPORATION, Taichung City (TW)

(72) Inventors: CHING-FANG WONG, Taichung City (TW); YU-WEI LIU, Taichung City (TW); WEI-LUN ZENG, Taichung City (TW); BANG-JIN YOU, Taichung City (TW)

(73) Assignee: CHENFENG OPTRONICS CORPORATION, Taichung City (TW)

(21) Appl. No.: 18/810,269

(22) Filed: Aug. 20, 2024

(30) Foreign Application Priority Data
Feb. 5, 2024 (TW) 113104467

(51) Int. Cl. G02F 1/1677; G02F 1/1333; G02F 1/1335; G02F 1/167

(52) U.S. Cl. CPC G02F 1/1677; G02F 1/13338; G02F 1/133502; G02F 1/133616; G02F 1/167

(57) ABSTRACT

A front-light glass display module includes an image display unit, an adhesive layer, and a front-light unit. The adhesive layer is stacked on one side of the image display unit, and is made of an optical clear adhesive and a buffer material. The front-light unit is installed on the adhesive layer and remote to the image display unit. The front-light unit has a glass sheet and a light-guiding structure. The glass sheet is stacked on the adhesive layer. The light-guiding structure is installed on at least one side of the glass sheet that faces or faces away from the adhesive layer. The light-guiding structure guides and transmits light to the image display unit uniformly. The front-light unit uses the high-strength glass sheet to eliminate the need of a protection layer for the conventionally used plastic structure, thereby reducing the overall thickness and weight while saving manufacturing costs.

### BACKGROUND OF THE INVENTION

### 1. Technical Field

The present invention relates to display modules, and more particularly to a front-light glass display module.

### 2. Description of Related Art

Conventionally, a non-active light-emitting article is equipped with a light-guiding structure to ensure its use in a dark environment. Such a light-guiding structure collects and guides the ambient light into the non-active light-emitting article, thereby making images displayed in the non-active light-emitting article visible to its users.

Most existing light-guiding structures are made of plastic materials that are usually fragile, making it necessary to protect the fragile, plastic light-guiding structure with an additional protection layer. However, this addition can consequently increase the thickness of the assembled light-guiding structure to 1 mm or more, leading to users' inferior use feel on the resulting article.

Moreover, the article can easily become unusable if the light-guiding structure itself is of low strength, making its service life undesirably short.

### SUMMARY OF THE INVENTION

A primary objective of the present invention is to address the issues of conventional plastic light-guiding structures about low strength, high manufacturing costs and inferior use feel caused by addition of a protection layer.

To achieve the foregoing objective, one embodiment of the present invention provides a front-light glass display module, which comprises an image display unit, an adhesive layer, and a front-light unit. The adhesive layer is stacked on one side of the image display unit, and is made of an optical clear adhesive and a buffer material. The front-light unit is installed on the adhesive layer and remote to the image display unit. The front-light unit comprises a glass sheet and a light-guiding structure. The glass sheet is stacked on the adhesive layer. The light-guiding structure is installed on at least one side of the glass sheet that faces or faces away from the adhesive layer. The light-guiding structure serves to guide and transmit light uniformly to the image display unit.

The front-light unit uses the high-strength glass sheet to eliminate the need of a protection layer for the conventionally used plastic structure, thereby reducing the overall thickness and weight while saving manufacturing costs. Additionally, the glass sheet provides better writing feel than the common plastic structures, thereby ensuring comfortable use.

### BRIEF DESCRIPTION OF THE DRAWINGS

FIG. 1 is a cross-sectional view of a front-light glass display module according to a first embodiment of the present invention.

FIG. 2 is a perspective view of a front-light unit according to the first embodiment of the present invention.

FIG. 3 is a cross-sectional view of a front-light glass display module according to a second embodiment of the present invention.

FIG. 4 is a cross-sectional view of a front-light glass display module according to a third embodiment of the present invention.

FIG. 5 is a cross-sectional view of a front-light glass display module according to a fourth embodiment of the present invention.

### DETAILED DESCRIPTION OF THE INVENTION

The following preferred embodiments when read with the accompanying drawings are made to clearly exhibit the above-mentioned and other technical contents, features and effects of the present invention. Through the exposition by means of the specific embodiments, people would further understand the technical means and effects the present invention adopts to achieve the above-indicated objectives. However, the accompanying drawings are intended for reference and illustration, but not to limit the present invention and are not made to scale.

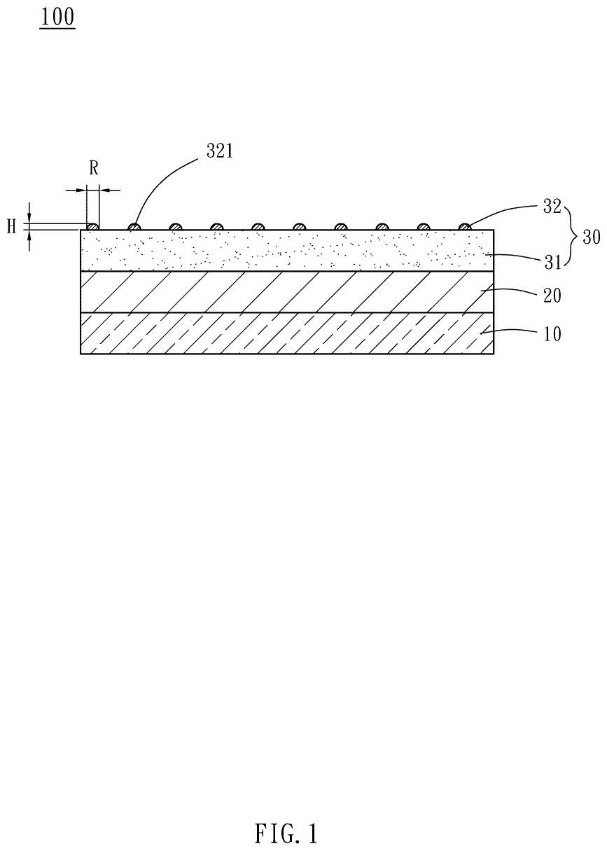

Referring to FIG. 1 through FIG. 5, in one embodiment of the present invention, a front-light glass display module 100 comprises an image display unit 10, an adhesive layer 20, and a front-light unit 30. Therein, the present invention is to be applied to a non-active light-emitting article. To be specific, the article herein refers to a device that makes displayed images or texts visible to users by receiving and reflecting the ambient light (such as an electronic paper).

The image display unit 10 comprises an E-ink display layer. Therein, the image display unit 10 receives and reflects the ambient light to make images or texts displayed by the E-ink display layer visible to users.

The adhesive layer 20 is stacked on one side of the image display unit 10. The adhesive layer 20 is made of an optical clear adhesive and a buffer material. The optical clear adhesive serves to adhere the image display unit 10 and the front-light unit 30 to the adhesive layer 20.

In the present embodiment, the buffer material accounts for 10% to 20% of the weight percentage of the adhesive layer 20, such as 10%, 11%, 12%, 13%, 14%, 15%, 16%, 17%, 18%, 19%, or 20%. The proportion endows the adhesive layer 20 with both good viscosity and good impact resistance. If the buffer material accounts for less than 10% of the weight percentage of the adhesive layer 20, the adhesive layer 20 would have significantly decreased impact resistance, leading to decreased overall structural strength of the display module 100. If the buffer material accounts for more than 20% of the weight percentage of the adhesive layer 20, the proportion of the optical clear adhesive would be too low to make the adhesive layer 20 properly adhesive, making the image display unit 10 and the front-light unit 30 tend to come off.

In the present embodiment, the buffer material is a phenyl-containing high polymer polymerized from monomers. The monomers have a main carbon chain length of between C6 and C18, with phenyl in the side chain. Therein, the buffer material comprises a reaction product of C18-unsaturated dimer fatty acid and polyvinylamine; a polymer of 4,4′-(1-methylethylidene)bisphenol and epichlorohydrin; or a mixture thereof.

The front-light unit 30 is installed on the adhesive layer 20 and remote to the image display unit 10. It comprises a glass sheet 31 and a light-guiding structure 32. The glass sheet 31 is stacked on the adhesive layer 20. The light-guiding structure 32 is on at least one side of the glass sheet 31 that faces or faces away from the adhesive layer 20. The light-guiding structure 32 guides and transmits light uniformly to the image display unit 10, so that the image display unit 10 can reflect light uniformly, thereby allowing users to see the images or texts displayed by the image display unit 10 clearly. Therein, the light-guiding structure 32 is formed on at least one side of the glass sheet 31 that faces or faces away from the adhesive layer 20 by means of screen printing. When the light-guiding structure 32 is installed on the side of the glass sheet 31 that faces the adhesive layer 20, the glass sheet 31 protects the light-guiding structure 32 from damage caused by foreign objects, thereby enhancing the overall structural strength and extending the service life of the disclosed display module 100.

In the present embodiment, the glass sheet 31 has a thickness of between 0.3 mm and 2 mm, such as 0.3, 0.4, 0.5, 0.6, 0.7, 0.8, 0.9, 1, 1.1, 1.2, 1.3, 1.4, 1.5, 1.6, 1.7, 1.8, 1.9, or 2 mm. By replacing the conventional plastic structure with the glass sheet 31, the front-light unit 30 of the present invention eliminates the need of a protection layer, thereby reducing the overall thickness and weight while saving manufacturing costs. In addition, the glass sheet 31 provides better writing feel than the common plastic structures, thereby ensuring comfortable use.

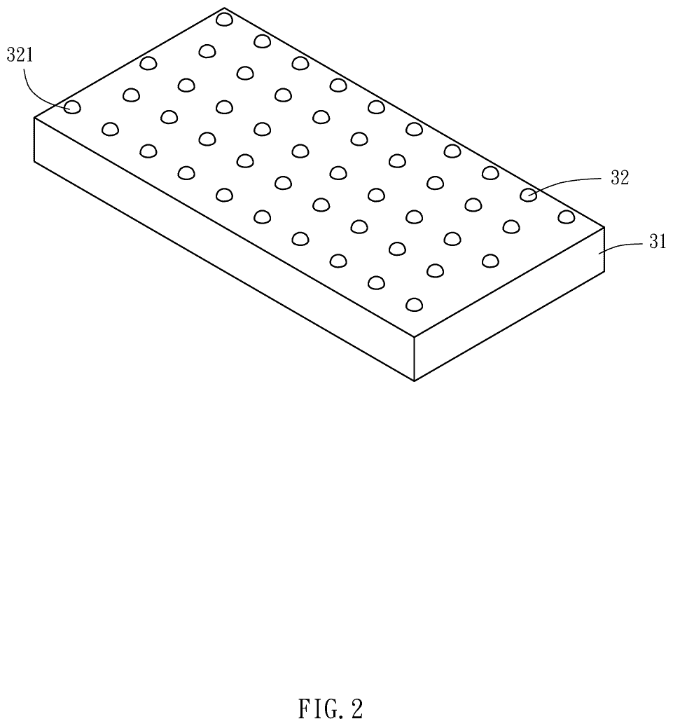

As shown in FIG. 1 and FIG. 2, in the present embodiment, the light-guiding structure 32 has a plurality of light-guiding portions 321 (not in scale in FIG. 2 for better illustrating the layout of the light-guiding portions 321). In the present embodiment, each of the light-guiding portions 321 is shaped as a hemisphere or a dome for better scattering light. In one embodiment, each of the light-guiding portions 321 has a diameter R of between 0.05 mm and 0.1 mm, such as 0.05, 0.055, 0.06, 0.065, 0.07, 0.075, 0.08, 0.085, 0.09, 0.095, or 0.1 mm. Each of the light-guiding portions 321 has a height H of between 3 μm and 15 μm, such as 3, 4, 5, 6, 7, 8, 9, 10, 11, 12, 13, 14, or 15 μm. Each of the light-guiding portions 321 has an optical uniformity of between 70% and 92%, such as 70%, 71%, 72%, 73%, 74%, 75%, 76%, 77%, 78%, 79%, 80%, 81%, 82%, 83%, 84%, 85%, 86%, 87%, 88%, 89%, 90%, 91%, or 92%. Each of the light-guiding portions 321 has a visible light transmission of between 70% and 92%, such as 70%, 71%, 72%, 73%, 74%, 75%, 76%, 77%, 78%, 79%, 80%, 81%, 82%, 83%, 84%, 85%, 86%, 87%, 88%, 89%, 90%, 91%, or 92%.

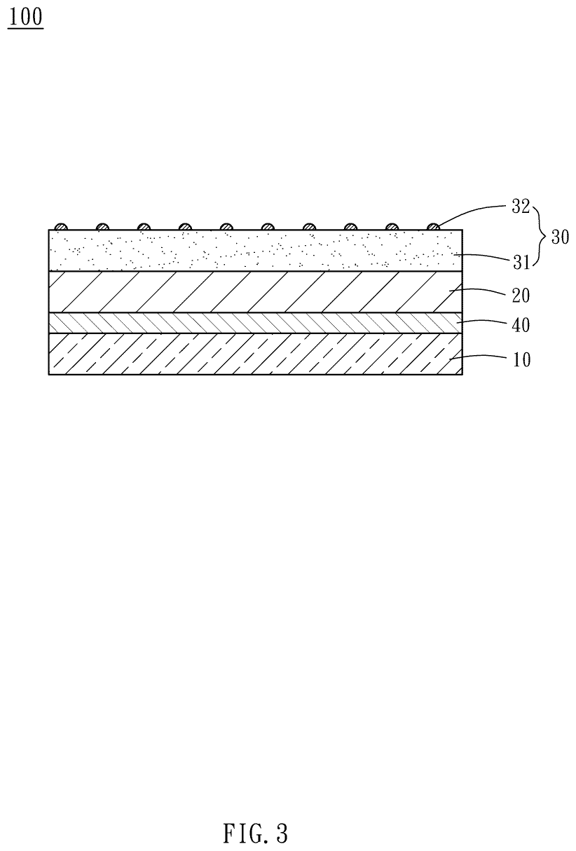

As shown in FIG. 3, in the second embodiment of the present invention, there is further a capacitive touch layer 40 located between the image display unit 10 and the adhesive layer 20. The capacitive touch layer 40 facilitates precise and easy operation for users to switch among images displayed by the image display unit 10.

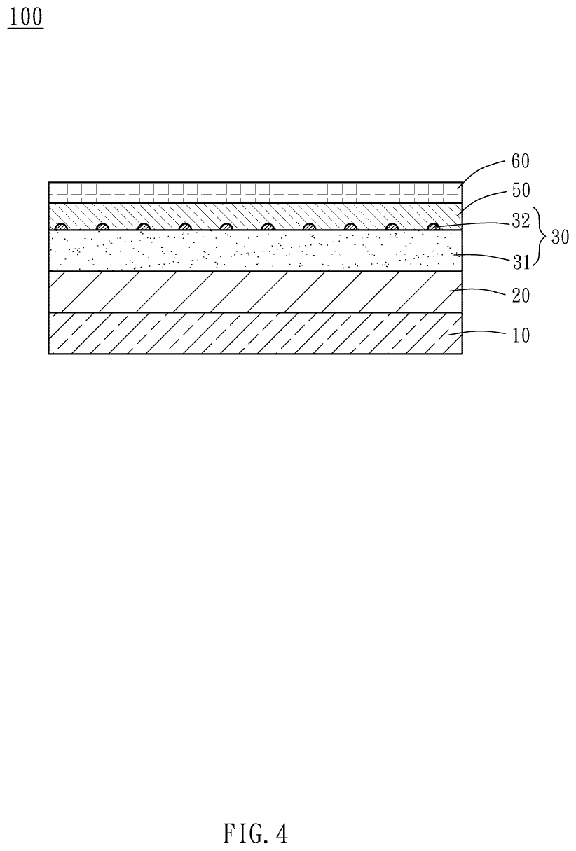

As shown in FIG. 4, in the third embodiment of the present invention, the front-light unit 30 further has an anti-glare layer 50 and an anti-fouling layer 60 stacked on its side facing away from the adhesive layer 20. Therein, the anti-glare layer 50 prevents the disclosed display module 100 from generating the glare, thereby protecting users' visual health. The anti-fouling layer 60 prevents foreign objects from entering and damaging the internal structure of the disclosed display module 100, thereby extending the service life of the present invention.

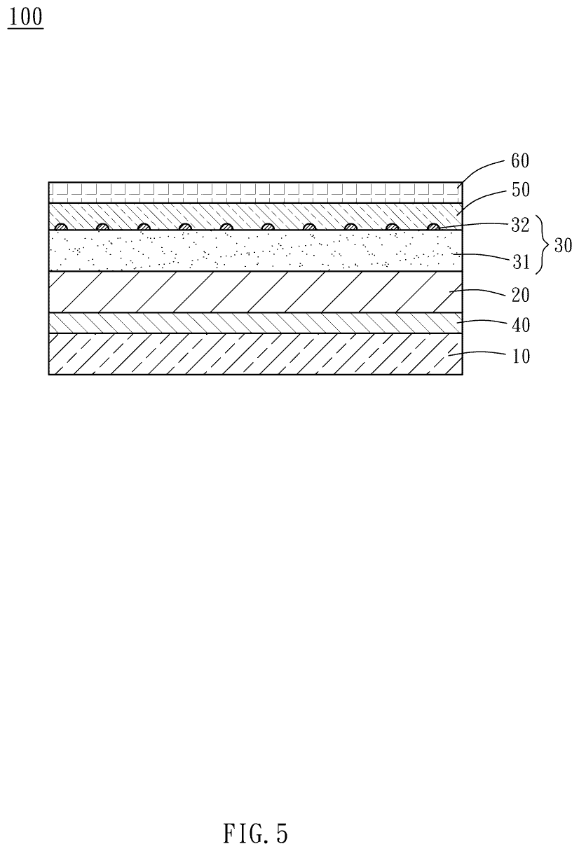

As shown in FIG. 5, in the fourth embodiment of the present invention, the disclosed display module 100 comprises all of the capacitive touch layer 40, the anti-glare layer 50, and the anti-fouling layer 60 to have all the advantages of these components, thereby ensuring comfortable use and enhancing the overall structural strength of the disclosed display module 100.

With the foregoing configurations, the present invention has the following advantages:
1. The front-light unit 30 uses the high-strength glass sheet 31 to eliminate the need of a protection layer for the conventionally used plastic structure, thereby reducing the overall thickness and weight while saving manufacturing costs. Additionally, the glass sheet 31 provides better writing feel than the common plastic structures, thereby ensuring comfortable use.
2. Furthermore, since glass has a high rigidity, the disclosed display module 100 is unlikely to deform over time, making the disclosed display module 100 more long-life and durable.
3. In virtue of the buffer material, the adhesive layer 20 further has both good viscosity and good impact resistance, and these contribute to a better overall structural strength of the disclosed display module 100, making the disclosed display module 100 less likely to be damaged by foreign objects.
4. The light-guiding structure 32 is formed by plural light-guiding portions 321 that are made by means of screen printing, and these uniformly distributed light-guiding portions 321 enable the light-guiding structure 32 to guide and uniformize light better.

The present invention has been described with reference to the preferred embodiments and it is understood that the embodiments are not intended to limit the scope of the present invention. Moreover, as the contents disclosed herein should be readily understood and can be implemented by a person skilled in the art, all equivalent changes or modifications which do not depart from the concept of the present invention should be encompassed by the appended claims.

What is claimed is:

1. A front-light glass display module, comprising:
an image display unit;
an adhesive layer, being stacked on one side of the image display unit, and made of a material containing an optical clear adhesive and a buffer material; and
a front-light unit, being installed on the adhesive layer and remote to the image display unit, and comprising a glass sheet and a light-guiding structure, wherein the glass sheet is stacked on the adhesive layer, and the light-guiding structure is installed on at least one side of the glass sheet that faces or faces away from the adhesive layer, so that the light-guiding structure guides and transmits light to the image display unit uniformly.

2. The front-light glass display module of claim 1, wherein the image display unit comprises an E-ink display layer.

3. The front-light glass display module of claim 1, wherein the buffer material accounts for 10% to 20% of a weight percentage of the adhesive layer.

4. The front-light glass display module of claim 1, wherein the buffer material is a phenyl-containing high polymer polymerized from monomers, in which the monomers have a main carbon chain length of between C6 and C18, with phenyl in a side chain.

5. The front-light glass display module of claim 4, wherein the buffer material comprises a reaction product of C18-unsaturated dimer fatty acid and polyvinylamine; a polymer of 4,4′-(1-methylethylidene)bisphenol and epichlorohydrin; or a mixture thereof.

6. The front-light glass display module of claim 1, wherein the glass sheet has a thickness of between 0.3 mm and 2 mm.

7. The front-light glass display module of claim 1, wherein the light-guiding structure has a plurality of light-guiding portions.

8. The front-light glass display module of claim 7, wherein each of the light-guiding portions has a diameter in a planar direction of the glass sheet and the diameter is of between 0.05 mm and 0.1 mm.

9. The front-light glass display module of claim 7, wherein each of the light-guiding portions has a height of between 3 μm and 15 μm.

10. The front-light glass display module of claim 7, wherein each of the light-guiding portions has an optical uniformity of between 70% and 92%.

11. The front-light glass display module of claim 7, wherein each of the light-guiding portions has a visible light transmission of between 70% and 92%.

12. The front-light glass display module of claim 7, wherein the light-guiding structure is installed on at least one of the sides of the glass sheet that faces or faces away from the adhesive layer by means of screen printing.

13. The front-light glass display module of claim 1, further comprising a capacitive touch layer located between the image display unit and the adhesive layer.

14. The front-light glass display module of claim 1, further comprising an anti-glare layer stacked on one side of the front-light unit that faces away from the adhesive layer.
